(19) United States
(12) Patent Application Publication
(10) Pub. No.: US 2006/0271963 A1
(43) Pub. Date: Nov. 30, 2006

(54) System and method for linking media data between a television and a remote control for easy access to information

(76) Inventors: Sai L. Mangu, (US); Rajagopal A., Annanagar (IN); Manjula Vidyanandarao, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/141,729

(22) Filed: May 31, 2005

(51) Int. Cl. H04N 7/173; H04N 5/445; G06Q 30/00; G07G 1/12; G06F 13/00; G06F 3/00; G07G 1/10

(52) U.S. Cl. 725/60; 705/25; 705/26; 725/112; 725/113

(57) ABSTRACT

A system and method for linking media data via a television and a remote control for easy access to product purchase information are described. The system includes a television and a remote control. The remote control includes a connect feature and at least one connection functionality. A user activates the connect feature to purchase a product being displayed on the television. The remote control receives filtered data from the television in response to the activation of the connect feature. The remote control then uses the filtered data and the at least one connection functionality to allow the user to purchase the product.

### BACKGROUND

The importance for the consumer product industry to continuously strive to offer convenient ways for consumers to purchase their products cannot be overstated. No doubt this is one of the reasons for advertising in the consumer's home via the television. For example, home shopping networks and advertisements or commercials display a telephone number or Web site that a viewer of television may call or visit in order to purchase products. Unfortunately, many times the viewer does not have a pen and/or paper readily available to write the telephone number or Web site down in order to purchase the product. Often times, even if the viewer does write down the telephone number or Web site, the viewer may not immediately take the necessary steps to purchase the product. Often, if the viewer does not take the time to purchase the product when advertised, the viewer may forget or lose interest in the future to purchase the product.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of an environment for linking media data via a television and a remote control for easy access to information, in which some embodiments of the present invention may operate;

FIG. 2 illustrates an embodiment of a remote control, in which some embodiments of the present invention may operate;

FIG. 3 illustrates a flow diagram of one embodiment of a process for the operation of linking media data via a television and a remote control for easy access to information;

FIG. 4 illustrates a flow diagram of one embodiment of a process for the operation of allowing the user to contact a call center via the remote control; and

FIG. 5 illustrates a flow diagram of one embodiment of a process for the operation of allowing the user to access a Web site via the remote control.

### DESCRIPTION OF EMBODIMENTS

A method and system for linking media data via a television and a remote control for easy access to information are described. Here, at least some of the problems described above with losing potential consumers of products advertised on television may be alievated by providing a convenient way for the viewer to purchase the product immediately after or while it is being advertised on television. In the following description, for purposes of explanation, numerous specific details are set forth. It will be apparent, however, to one skilled in the art that embodiments of the invention can be practiced without these specific details.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

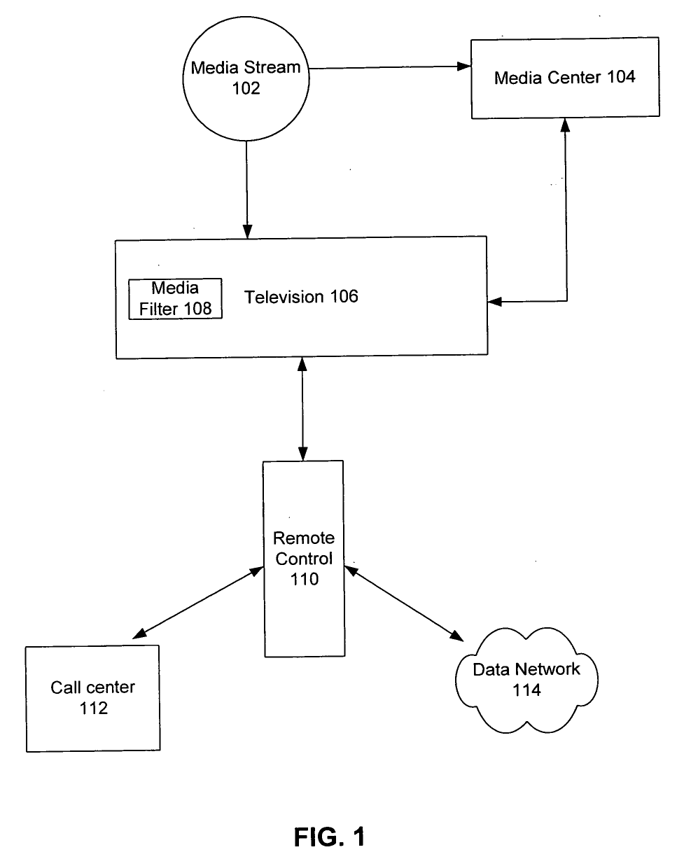

FIG. 1 illustrates one embodiment of an environment for linking media data via a television and a remote control for easy access to information, in which some embodiments of the present invention may operate. The specific components shown in FIG. 1 represent one example of a configuration that may be suitable for the invention and is not meant to limit the invention.

Referring to FIG. 1, a media stream 102, a media center 104, a television 106, a remote control 110, a call center 112 and a data network 114 are shown. Television 106 may include a media filter 108. Although one of each of a television, a remote control, a media stream, a media center, a call center and a data network are shown in FIG. 1, it is understood that any number of televisions, remote controls, media streams, media centers, call centers and data networks may be present.

At a high level and in an embodiment of the invention, media stream 102 is being fed into television 106 as either a live broadcast or as a prerecorded broadcast via media center 104. A user who is currently viewing television 106 may decide that he or she wishes to purchase whatever is being currently advertised on television 106. The user may activate a connect feature on remote control 110. In response to the connect feature being activated, television 106 may use media filter 108 to filter a telephone number to a call center and/or a Uniform Resource Locator (URL) address to a Web site. Remote control 110 may automatically dial the telephone number and connect the user to the call center to purchase the desired product. Remote control 110 may also automatically use the URL address to load a Web page that the user may interact with to purchase the desired product. This allows the user to easily purchase a product within seconds of viewing its advertisement on television 106.

Other embodiments of the invention may include more or less components as described in FIG. 1. For example, the functionality of two or more components of FIG. 1 may be combined into one component. Likewise, the functionality of one component of FIG. 1 may be separated and performed by more than one component. Each component shown in FIG. 1 may be implemented as a hardware element, as a software element executed by a processor, as a silicon chip encoded to perform its functionality described herein, or any combination thereof. Each of the components in FIG. 1 are described next in more detail.

In an embodiment of the invention, media stream 102 may be a digital stream of data generated by a television cable company, a broadcast company, a satellite company, and so forth. The output of media stream 102 may be received by media center 104 and/or television 106. Media stream 102 may represent a program with associated advertisements. Each advertisement may have an associated telephone number to a call center or a URL address to a Web site that a user may contact to purchase the product being advertised. In another embodiment of the invention, media stream 102 may represent a home shopping program. Here, each product advertised on the home shopping program may have an associated telephone number to a call center or a URL address to a Web site that a user may contact to purchase the product being advertised. In yet another embodiment of the invention, media stream 102 may be a program with an associated telephone number to a call center or a URL address to a Web site that a user may contact to find out more information about the program itself, such as the actors, directors, title, when produced, and so forth. The different types of associated data that may be contained in media stream 102 is endless and the above examples are not meant to limit the invention.

As described above, media stream 102 may be fed into television 106 as either a live broadcast or as a prerecorded broadcast via media center 104. In an embodiment of the invention, media center 104 includes personal video recorder (PVR) functionality. PVR is a generic term for a device that is similar to a video cassette recorder (VCR) but records television data in digital format as opposed to the VCR's analog format. VCRs utilize analog tapes to record and play programs broadcast over television, but PVRs encode video data in MPEG-1 or MPEG-2 formats and store the data in a hard drive. In the case of digital media streams, the PVR routes the previously encoded digital media stream to local storage. PVRs may encode other types of data and other types of data may be added or substituted for those described as new types of data are developed and according to the particular application for the PVR.

PVRs have all of the same functionality of VCRs (recording, playback, fast forwarding, rewinding, pausing, etc.) plus the ability to instantly jump to any part of the program without having to rewind or fast forward the data stream. PVRs allow a user to view a broadcasted program as a time shifted event. A PVR is also referred to as a hard disk recorder (HDR), digital video recorder (DVR), personal video station (PVS), or a personal TV receiver (PTR).

In an embodiment of the invention, television 106 is a device that incorporates filtering functionality via media filter 108. Media filter 108 may be used to filter a telephone number and/or a URL address from media stream 102, although the present invention is not limited in this regard. Television 106 may also be a monitor, a projector, a conventional analog television receiver, or any other kind of perceivable video display with a tuner that incorporates the filtering functionality as described above. The audio portion of the output may be routed through an amplifier, such as an audio/video (A/V) receiver or a sound processing engine, to headphones, speakers or any other type of sound generation device.

In an embodiment of the invention, call center 112 may be a center where people are waiting to take orders for one or more products advertised on television. In an embodiment of the invention, data network 114 may be the Internet, a local area network (LAN), a wide area network (WAN), or any other searchable medium capable of storing on-line information. Remote control 110 searches data networks 114 for the appropriate Web site based on the URL address provided by television 106.

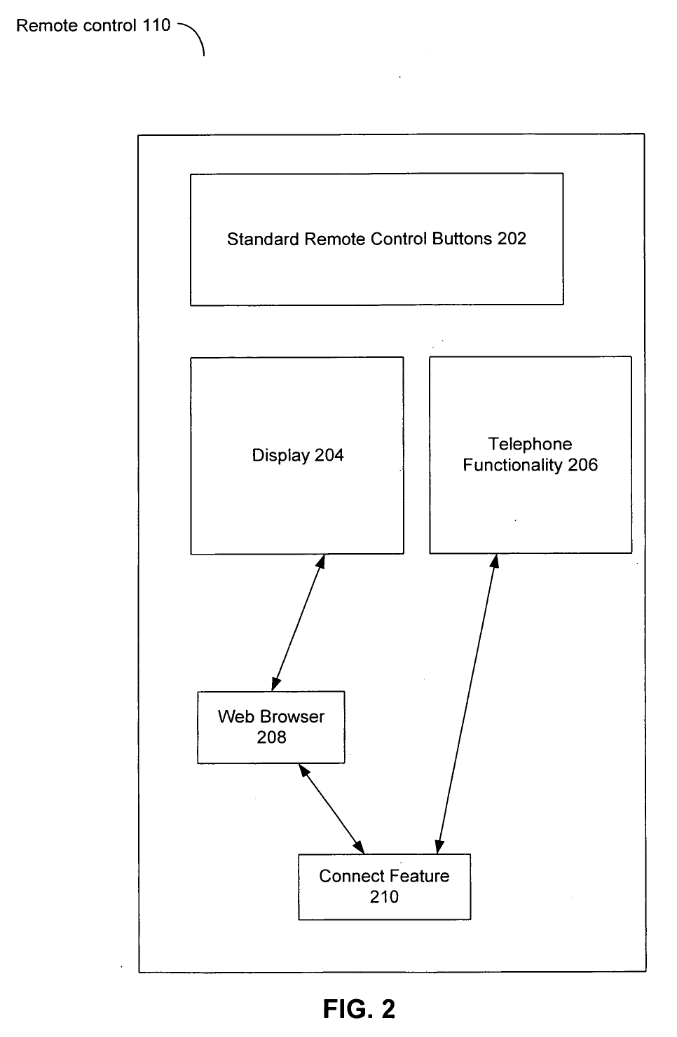

Remote control 110 is any device capable of receiving the filtered telephone number and/or URL address from television 106 and capable of connecting the user with the call center associated with the telephone number and/or the Web site associated with the URL address. For example, remote control 110 could be, but is not limited to, a Web enabled mobile phone, a laptop, a personal computer, a personal digital assistant (PDA), and so forth. Remote control 110 is described further with reference to FIG. 2.

Referring to FIG. 2, an example remote control 110 is shown. This example remote control is shown for illustration purposes only and is not meant to limit the invention. Remote control 110 may include, but is not necessarily limited to, one or more standard remote control buttons 202, a display 204, telephone functionality 206, a Web browser 208 and a connect feature 210. One or more control buttons on remote control 110 may be implemented as a hard button or switch. One or more control buttons on remote control 110 may also be implemented as a soft button, for example, implemented via a liquid crystal display (LCD) touch screen on the remote control. Other embodiments of the invention may include more or less components as described in FIG. 2. For example, the functionality of two or more components of FIG. 2 may be combined into one component. Likewise, the functionality of one component of FIG. 2 may be separated and performed by more than one component. Each component shown in FIG. 2 may be implemented as a hardware element, as a software element executed by a processor, as a silicon chip encoded to perform its functionality described herein, or any combination thereof. Each of the components in FIG. 2 are described next in more detail.

Standard remote control buttons 202 may include control buttons found on a typical television remote control that are used to operate the television. Display 204 may be implemented as a LCD screen that allows the user to view pages from a Web site. Telephone functionality 206 allows the user to connect to a call center to purchase a product and may include a speaker, microphone, touch tone keypad, frequency generator, and so forth. Web browser 208 allows the user to interact with a Web site to purchase a product. Web browser 208 may be any application that is used to locate and display Web pages. Connect feature 210 is activated by the user when he or she wants to purchase or find more information about a product being advertised on television 106.

Operations for the above components described in FIGS. 1 and 2 may be further described with reference to the following figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

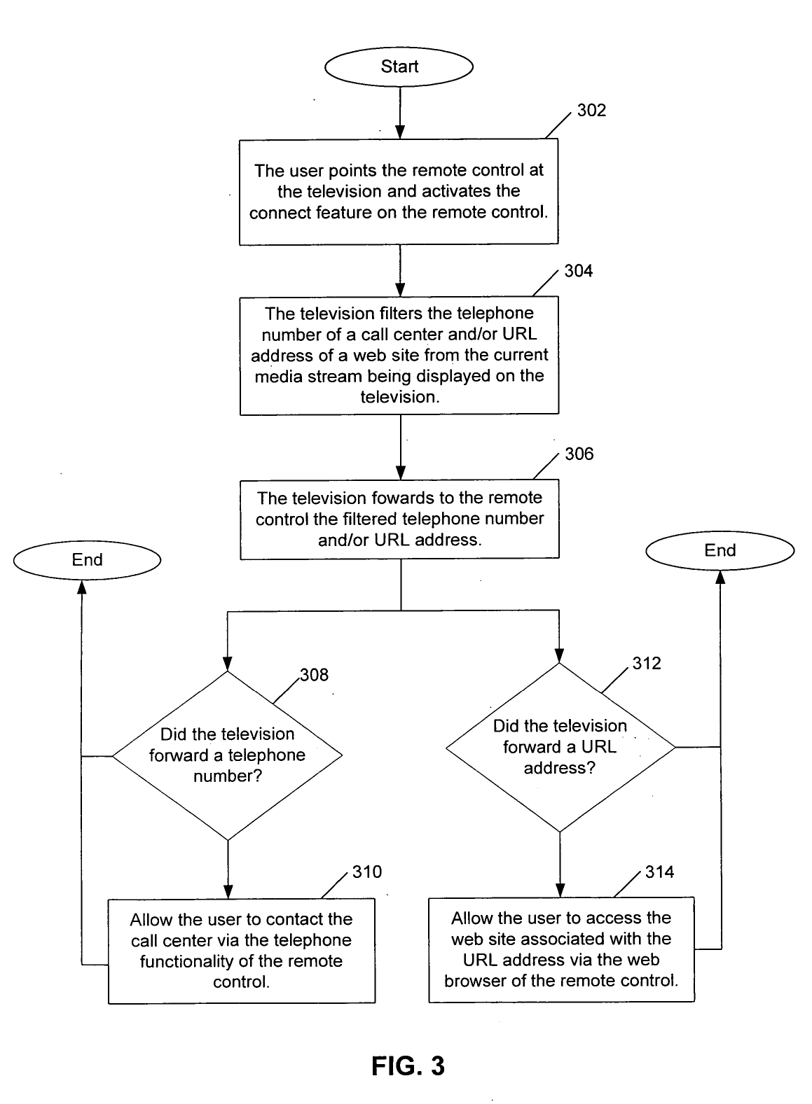

FIG. 3 illustrates a flow diagram of one embodiment of a process for the operation of linking media data via a television and a remote control for easy access to information. In an embodiment of the invention, a user is watching on television a home shopping network or an advertisement for a product for purchase. The user decides that he or she would like to purchase the product currently being displayed on the television. Referring to FIG. 3, the process begins at processing block 302 where the user points a remote control (such as remote control 110 in FIGS. 1 and 2) at a television (such as television 106 in FIG. 1) and activates a connect feature (such as connect feature 210 in FIG. 2) on the remote control.

At processing block 304 and in response to the connect feature being activated, the television filters (from the current media stream being displayed on the television) a telephone number of a call center and/or URL address of a Web site that the user may contact in order to purchase the product. The current media stream may be a live media stream or a recorded media stream via, for example, a media center (such as media center 104 in FIG. 1). Here, the current media stream may contain a telephone number or a URL address or both. The media stream may also contain other types of data that may be used by the present invention to allow the user to purchase a product or find additional information about what is currently being displayed on the television.

At processing block 306, the television forwards to the remote control the filtered telephone number and/or URL address. The process in FIG. 3 then branches to both decision block 308 and decision block 312.

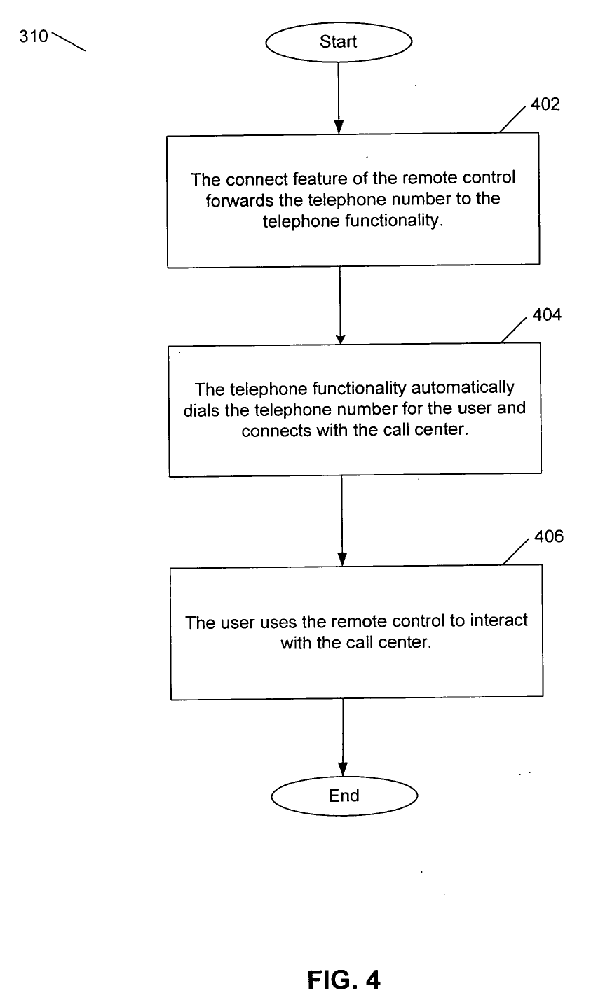

At decision block 308, it is determined whether the television forwarded a telephone number. If so, at processing block 310, the user may contact the call center associated with the telephone number via the telephone functionality of the remote control (such as telephone functionality 206 of FIG. 2) to purchase the product. Processing block 310 is described in more detail with reference to FIG. 4 below.

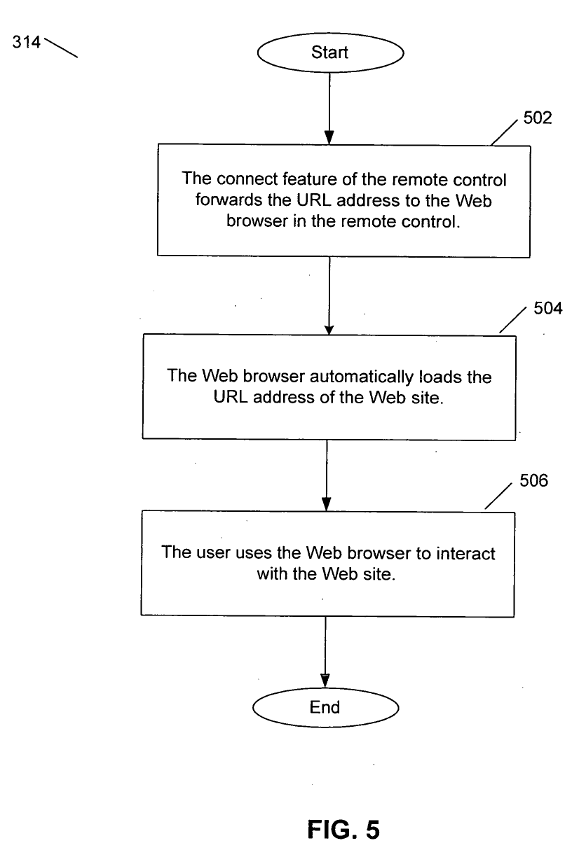

At decision block 312, it is determined whether the television forwarded a URL address. If so, at processing block 314, the user may interact with the Web site associated with the URL address via a Web browser (such as Web browser 208 of FIG. 2) to purchase the product. Processing block 314 is described in more detail with reference to FIG. 5 below.

FIG. 4 illustrates a flow diagram of one embodiment of a process for the operation of allowing the user to contact a call center via the remote control (processing block 310 of FIG. 3). Referring to FIG. 4, the process begins at processing block 402 where the connect feature of the remote control forwards the telephone number to the telephone functionality. The telephone functionality automatically dials the number for the user and connects the user with the call center at processing block 404. The user then uses the remote control to interact with the call center to purchase the desired product at processing block 406.

FIG. 5 illustrates a flow diagram of one embodiment of a process for the operation of allowing the user to interact with a Web site via the remote control (processing block 314 of FIG. 3). Referring to FIG. 5, the process begins at processing block 502 where the connect feature of the remote control forwards the URL address to the Web browser in the remote control. The Web browser automatically loads the URL address at processing block 504. The user uses the Web browser to interact with the Web site to purchase the desired product at processing block 506.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions above are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A device, comprising:
a connect feature; and
at least one connection functionality, wherein a user activates the connect feature to purchase a product being displayed on a television, wherein the device receives filtered data from the television in response to the activation of the connect feature, and wherein the device uses the filtered data and the at least one connection functionality to allow the user to purchase the product.

2. The device of claim 1, wherein the at least one connection functionality includes telephone functionality and wherein the filtered data includes a telephone number to a call center.

3. The device of claim 1, wherein the at least one connection functionality includes a Web browser and wherein the filtered data includes a Uniform Resource Locator (URL) address.

4. The device of claim 1, wherein the at least one connection functionality includes telephone functionality and a Web browser and wherein the filtered data includes a telephone number to a call center and a Uniform Resource Locator (URL) address.

5. The device of claim 1, further comprising television remote control functionality.

6. The device of claim 1, wherein the filtered data is filtered from a current media stream being displayed on the television.

7. The device of claim 6, wherein the current media stream being displayed on the television is a live media stream.

8. The device of claim 6, wherein the current media stream being displayed on the television is a previously recorded media stream.

9. A method, comprising:
activating a connect feature in a device to purchase a product being displayed on a television;
receiving filtered data from the television in response to the activation of the connect feature; and
using the filtered data and at least one connection functionality to allow the user to purchase the product.

10. The method of claim 9, wherein the at least one connection functionality includes telephone functionality and wherein the filtered data includes a telephone number to a call center.

11. The method of claim 9, wherein the at least one connection functionality includes a Web browser and wherein the filtered data includes a Uniform Resource Locator (URL) address.

12. The method of claim 9, wherein the at least one connection functionality includes telephone functionality and a Web browser and wherein the filtered data includes a telephone number to a call center and a Uniform Resource Locator (URL) address.

13. The method of claim 9, wherein the filtered data is filtered from a current media stream being displayed on the television.

14. The method of claim 13, wherein the current media stream being displayed on the television is a live media stream.

15. The method of claim 13, wherein the current media stream being displayed on the television is a previously recorded media stream.

16. A system, comprising:
a television; and
a remote control, wherein the remote control includes a connect feature and at least one connection functionality, wherein a user activates the connect feature to purchase a product being displayed on the television, wherein the remote control receives filtered data from the television in response to the activation of the connect feature, and wherein the remote control uses the filtered data and the at least one connection functionality to allow the user to purchase the product.

17. The system of claim 16, wherein the at least one connection functionality includes telephone functionality and wherein the filtered data includes a telephone number to a call center.

18. The system of claim 16, wherein the at least one connection functionality includes a Web browser and wherein the filtered data includes a Uniform Resource Locator (URL) address.

19. The system of claim 16, wherein the at least one connection functionality includes telephone functionality and a Web browser and wherein the filtered data includes a telephone number to a call center and a Uniform Resource Locator (URL) address.

20. The system of claim 16, wherein the remote control includes television remote control functionality.

21. The system of claim 16, wherein the filtered data is filtered from a current media stream being displayed on the television.

22. The system of claim 21, wherein the current media stream being displayed on the television is a live media stream.

23. The system of claim 21, wherein the current media stream being displayed on the television is a previously recorded media stream.

24. A machine-readable medium containing instructions which, when executed by a processing system, cause the processing system to perform a method, the method comprising:
activating a connect feature in a device to purchase a product being displayed on a television;
receiving filtered data from the television in response to the activation of the connect feature; and
using the filtered data and at least one connection functionality to allow the user to purchase the product.

25. The machine-readable medium of claim 24, wherein the at least one connection functionality includes telephone functionality and wherein the filtered data includes a telephone number to a call center.

26. The machine-readable medium of claim 24, wherein the at least one connection functionality includes a Web browser and wherein the filtered data includes a Uniform Resource Locator (URL) address.

27. The machine-readable medium of claim 24, wherein the at least one connection functionality includes telephone functionality and a Web browser and wherein the filtered data includes a telephone number to a call center and a Uniform Resource Locator (URL) address.
